(19) United States
(12) Patent Application Publication
(10) Pub. No.: US 2013/0026758 A1
(43) Pub. Date: Jan. 31, 2013

(54) METHOD FOR CONTROLLING AEROGENERATORS FOR PRODUCING ELECTRICAL ENERGY

(71) Applicant: Giorgio Moretti, Firenze (IT)

(72) Inventor: Giorgio Moretti, Firenze (IT)

(21) Appl. No.: 13/637,104

(22) PCT Filed: Mar. 25, 2011
(86) PCT No.: PCT/IB2011/000652

§ 371 Date: Sep. 25, 2012

(30) Foreign Application Priority Data
Mar. 25, 2010 (IT) P02010A000003

(51) Int. Cl. H02P 9/04

(52) U.S. Cl. 290/44

(57) ABSTRACT

A method for controlling an aerogenerator (1) for producing electrical energy of the type comprising an arrangement of aerodynamic elements (2) that rotate on a common shaft (3), sensors (4) for measuring at least the speed of the wind incident upon said elements (2), an alternator unit (5) associated with the rotation of the shaft (3) for generating electrical energy supplied to a use point (7) and/or to a battery (8) or for transmitting a mechanical torque to the shaft (3), and a control unit (6) associated with the sensor (4) and with the alternator (5) in order to control the alternator (5).

### TECHNICAL FIELD

This invention addresses the sector of aerogenerators or wind turbines for producing electrical energy.

Preferably, the invention applies to aerogenerators belonging to the class of small, variable-speed turbines, that is to say, with reference to a classification based on the IEC certification requirements which define a small turbine (SWT—Small Wind Turbine) a wind turbine having a swept surface area smaller than 200 m2, with power ratings from 0 to approximately 100 kW.

### Prior Art

Up to the present, this range of power ratings includes very different technologies, unlike the sector of megawatt turbines, where the technological solutions are relatively well-established and optimized.

Small aerogenerators differ according to the configuration of the turbine, which may be of the vertical or horizontal axis type, the number of blades, the type of control, the electromechanical power unit and the materials used. Small wind turbines are generally classified into turbines where the propelling element drives a shaft that is positioned horizontally, and turbines where the driven shaft is positioned vertically.

The former are more common but, although their main advantage is that they can start more easily at low wind speeds, they require a directional system to direct the propeller correctly relative to the direction of the wind, and in some cases they are excessively noisy.

Vertical-axis wind turbines do not require a directional system because their performance is independent of wind direction, and they also do not, generally speaking, require systems to slow them down when the wind is too strong. Further, they are inherently less noisy and allow the power generator, or alternator, to be fitted at the base of the turbine, thus lowering the barycentre of the turbine-alternator assembly.

In both vertical and horizontal axis wind turbines, the energy efficiency of the turbine is quantitatively described by the power curve, that is to say, the relation existing between wind speed and the power generated by the turbine.

The power curve of a turbine may also be defined as the relation existing between the TSR (Tip Speed Ratio)—or λ, that is, the ratio between the peripheral speed of the turbine and the speed of the wind incident upon it—and the power generated by the turbine.

Generally speaking, in Savonius type turbines, the maximum value of the TSR is 1, while in Darrieus type turbines the TSR may have higher values, up to 4 or 5, depending on the configuration of the turbine.

The power curve of a wind turbine is normally calculated based on experimental measurements carried out on the turbine in a wind gallery and, in theory, should make it possible to predetermine the amount of energy that the turbine can generate under defined wind conditions.

In reality, however, under actual working conditions, the energy produced by low-power wind turbines, that is to say, those belonging to the category of “small wind turbines” whose rated output is less than 100 kW, is significantly lower than the theoretical power output based on the power curve.

In effect, in the specific case of low-power turbines, there are inherent drawbacks which reduce the efficiency of the conversion of kinetic wind energy to electrical energy.

A first drawback is due to the minimum wind speed necessary to overcome the inertia from a stationary condition and to start the turbine (v>3 m/s).

Consequently, the energy potentially available for wind regimes under this threshold is not generally exploited until after a certain transient has elapsed, which may even be very extended in time.

Another drawback is the low efficiency of the turbine in turbulent wind regimes, which can be attributed to the dynamic behaviour of the rotor, that is, to the duration of the transients necessary to bring the rotor to nominal rotation conditions during rapid changes in the wind regime. Such transients may last many seconds and, in turbulent or variable wind regimes, this inertia once again translates as a significant loss of energy produced.

These factors, added to others which have not been mentioned, lead to substantial differences between actual and theoretical power output, thus increasing the cost of energy production.

### DISCLOSURE OF THE INVENTION

This invention has for an aim to overcome the above mentioned drawbacks by providing a method that can optimize aerogenerator control through a machine learning process based on the measurement of weather conditions. Another aim is to provide an aerogenerator control method which can exploit wind regimes of limited intensity, approximately between 2 and 4 m/s, and which therefore permits a higher energy efficiency.

The above aims are achieved in a method according to the accompanying claims.

Experts in the trade will better appreciate these and other aims and technical advantages of the invention from the following description with reference to the accompanying drawings illustrating a preferred non-limiting embodiment of it.

### BRIEF DESCRIPTION OF THE DRAWINGS

In the drawings:

FIG. 1 schematically illustrates an aerogenerator,

FIG. 2 shows a block diagram of the method according to the invention,

FIG. 3 shows a set of graphs representing certain characteristics of the aerogenerator as a function of the incident wind speed.

### PREFERRED EMBODIMENTS OF THE INVENTION

Described with reference to the accompanying drawings is a method for controlling an aerogenerator 1 for producing electrical energy comprising aerodynamic elements 2 which can rotate about a common vertical or horizontal axis shaft 3 for transmitting a mechanical torque to an alternator unit 5 when the elements 2 are struck by a wind flow W, and consequently generating electrical energy which will be used, through an inverter 9, to power a use point 7 and/or a battery unit 8.

The alternator 5 is also controlled by a control unit 6 capable of varying the electrical load applied to the alternator and also driving the alternator as a motor, that is, converting the energy accumulated in the battery 8 (or in capacitors set up for the purpose) into a mechanical torque transmitted to the elements 2 through the shaft 3.

The electrical circuit for the conversion, transmission and accumulation of the energy produced does not per se form the subject-matter of this invention and is not therefore described in more detail.

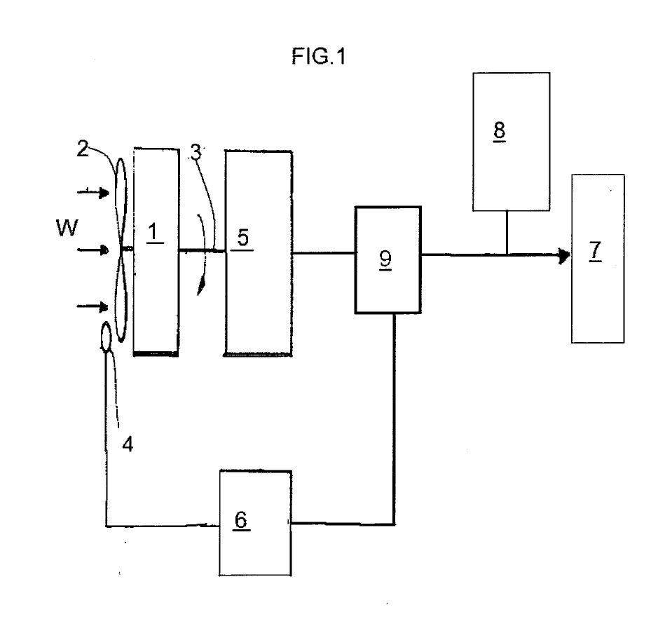

Again with reference to FIG. 1, the aerogenerator described comprises one or more sensors 4 connected to the unit 6 for measuring at least the speed of the wind incident upon the elements 2, and preferably also the wind direction and other parameters which can influence turbine operation, such as air temperature and humidity.

According to a first aspect of it, the invention comprises profiling the weather conditions of the turbine installation site and establishing a correlation between the weather conditions and the operating parameters of the turbine itself in order to optimize one or more of its performance specifications.

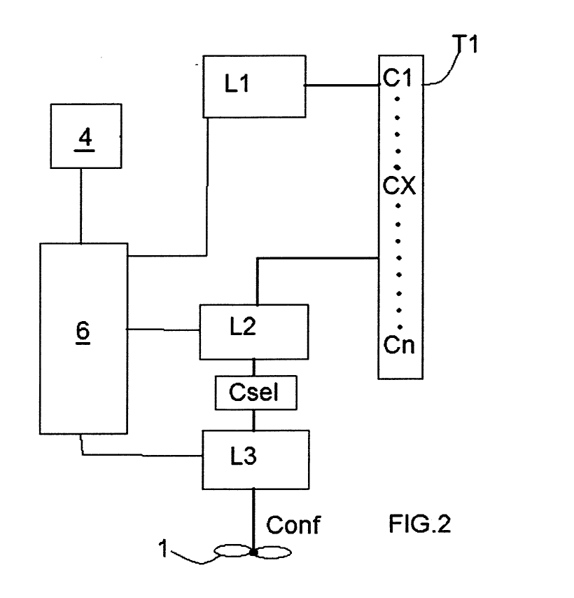

More specifically, as illustrated schematically in FIG. 2, the method according to the invention comprises creating (block L1) a history table T1 based on an observation over time of actual weather conditions and which are identified as samples Cx each associated with a weather condition based for example on the measurement of wind speed and/or direction, or any other parameter considered significant for one or more of the performance specifications of the aerogenerator (efficiency, maximum power output, etc.).

According to the method of the invention, each current reading of the sensors 4, which may be performed continuously or periodically, is associated with one or more possible successive weather conditions and from these a most likely expected condition Csel (block L2) is selected based on historical observations over time, that is to say, based on the past readings of the sensors 4.

Advantageously, the samples Cx are associated with a time marking (for example, time/day/month/year or time/day) which constitutes one of the criteria used by the prediction logic to determine the likelihood of recurrence of the weather condition corresponding to the sample, for example based on the constancy of recurrence of the weather condition upon recurrence of the same time marking.

During the operation of the aerogenerator and based on the current reading of the sensors 4, the logic (block L2) then selects from this set of samples a preferred sample Csel which is most likely to match the successive expected weather conditions.

Based on the sample Csel identified by the logic, the method comprises a step of assessing the opportunity for modifying the configuration or succession of operating configurations Conf of the aerogenerator (block L3) to achieve the optimum value of the required performance specification, for example by acting on the torque applied to the alternator shaft and hence on the rotation speed of the turbine.

Advantageously, in a preferred embodiment of the method, the values in the Table T1 are updated and/or the sample Csel created through a machine learning process.

One of the advantages offered by the method of the invention is the fact that the measured values of the characteristic weather condition parameters can be correlated immediately, that is, without any transient periods, with the optimum parameters of the aerogenerator in order to obtain the required performance specification, such as, for example, efficiency and/or maximum power output or actual power output.

More specifically, with the method according to the invention, it is possible, on a probabilistic basis, to distinguish whether a certain weather condition measured by the sensors will last for a long enough time to make it useful to modify or correct the configuration parameters of the turbine, or whether its duration will be so limited that correction is not advisable.

Based on this correlation, the unit 6 is therefore able to control the operation of the alternator, for example by varying or not varying the electrical load applied to the inverter 9, in such a way as to maintain optimum operating conditions in terms of energy conversion efficiency and maximum power output.

By way of an example, one characteristic configuration parameter of the aerogenerator is efficiency expressed as a function of the TSR (that is, the ratio between the peripheral speed of the elements 2 and the speed of the wind incident upon them measured by the sensor 4). That way, when wind speed changes, the unit 6 modifies the electrical load applied to the alternator until it finds the speed of the elements 2 that satisfies the condition of maximum efficiency.

In this embodiment of the method, the efficiency and/or maximum power output or actual power output are determined by a probabilistic correlation and the unit 6 can automatically control the operation of the alternator to maintain the optimum working conditions even with variations in weather conditions due to seasonal phenomena or other unforeseeable events.

According to another advantageous aspect of the invention, the control unit 6 is associated with the sensor 4 and with the alternator 5 to control the latter in accordance with wind speed and/or direction measured by the sensor 4, especially in the presence of low intensity wind regimes, for example for winds below 2-5 m/s.

Under these conditions, the sensor 4 transmits a wind speed value V1 to the unit 6 and compares it with a bottom limit value VO which is associated with the aerogenerator 1 and which is the wind speed threshold below which the aerogenerator shaft 3, on account of inertia, cannot reach a rotational speed RO sufficient to start the aerogenerator and/or keep energy conversion efficiency at the level considered satisfactory.

In this situation, in conformity with the invention, if following the control logic algorithm the measured conditions are considered sufficiently likely to last, the unit 6 supplies power to the aerogenerator, that is to say, in the case described, it drives the alternator 5 to act as a motor powered by the battery 8 or by the capacitors, in order to cause the shaft 3 to rapidly reach a speed R1 which corresponds to a capacity of the aerogenerator to exploit the incident wind to produce electrical energy.

Upon reaching the speed R1, the alternator switches to being an electric generator again and produces energy that is accumulated in the battery 8 and/or transferred to the use point 7.

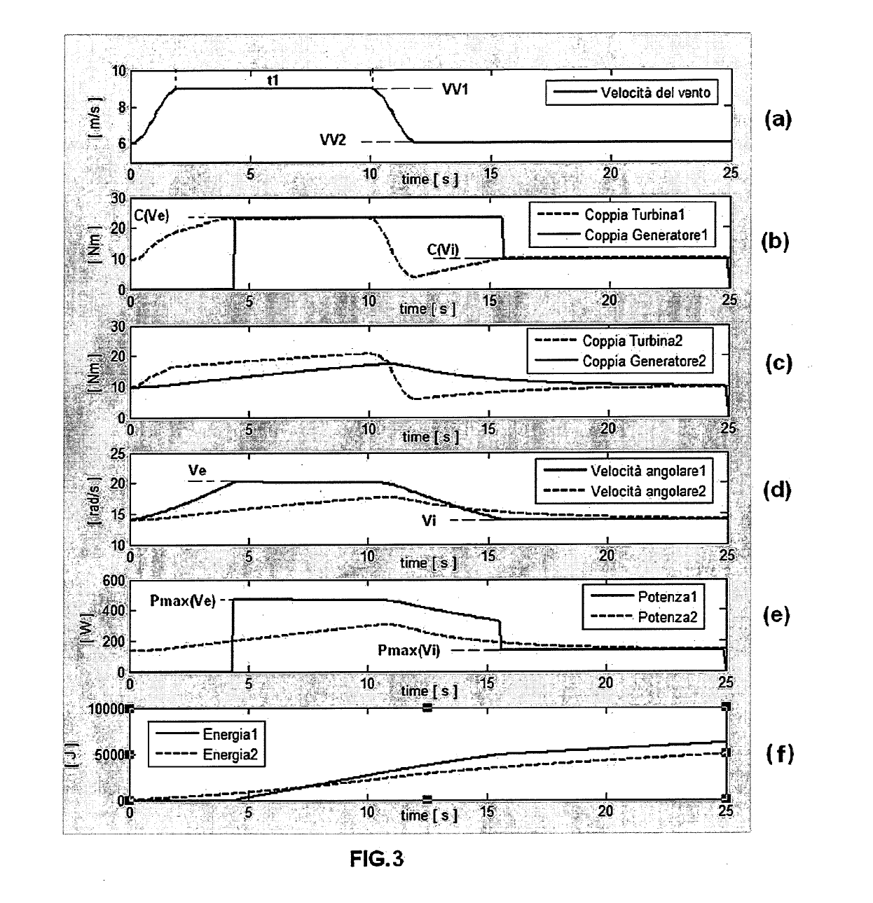

FIG. 3 schematically illustrates the operation of an aerogenerator controlled with the method of the invention in a possible special case of wind prediction, and shows how the aerogenerator 1 manages to generate electrical energy in conditions where such energy would otherwise be unavailable.

The embodiment of the method illustrated applies to the case where a gust of wind increasing to around 10 m/s is predicted and expected to last for approximately 10s. It will be understood, however, that the method is applicable to any possible expected condition of weather parameters (in this case, intensity and duration of wind gust) and of aerogenerator operating parameters (in this case, torque applied to the generator). More specifically:
graph (a) shows wind speed versus time;
graph (b) shows the turbine torque and generator torque curves obtained with the method according to the invention (index 1) as a function of wind speed;
graph (c) shows the turbine torque and generator torque curves obtained with a conventional method of controlling the generator torque (index 2) optimized as a function of the angular speed of the aerogenerator (curve (d));
graph (d) shows angular speed versus time of the aerogenerator controlled with the method according to the invention (index 1) or with the conventional method (index 2);
graph (e) shows power versus time of the aerogenerator controlled with the method according to the invention (index 1) or with the conventional method (index 2);
graph (f) shows energy versus time for energy generated by the aerogenerator controlled with the method according to the invention (index 1) or with the conventional method (index 2).

During operation, at time t=0 the system predicts a gust of wind increasing to an upper value VV1 of approximately 9 m/s and of duration t1 of approximately 10s and then returning to a lower steady value VV2 of 6 m/s.

The curve (b) shows that the resistant torque of the generator is zeroed to allow the aerogenerator to be accelerated rapidly (curve (d)) until reaching the speed Ve corresponding to the balance torque C(Ve) (curve (b)) between generator and turbine and then the maximum power condition Pmax(Ve) (curve (e) index 1).

When a gust of wind is predicted having an acceleration that exceeds a predetermined value, besides reducing to zero the resistant torque of the generator the control unit 6 causes the alternator 5 be activated as a motor. This transmits a mechanical torque to the aerodynamic elements 2 trough the shaft 3 and then determines an active acceleration of the elements. In this way, an optimal rotation condition is reached with respect to the highest speed of the gust in less time than only reducing to zero the resistant torque, allowing the system to operate at maximum efficiency for a grater percentage of the gust duration time.

At the end of the gust, generator torque control continues to be maintained at the value C(Ve) until the speed of the aerogenerator reaches a lower value Vi corresponding to a balance torque C(Vi). Under these conditions, the control causes a reduction in generator torque (curve (b) index 1) to the value C(V1) corresponding to the maximum power Pmax(Vi).

In the conventional case represented by the index 2 of the curves b-c-d-e, the generator torque is set according to a value that follows the maximum power (curve (e) index 1) relative to the speed of the aerogenerator (curve (d), index 1) so that when the turbine slows down on account of reduced wind speed, the turbine and generator torque values will gradually draw closer to each other again (curve (c) index 2).

The graph (f), expressed in J, shows the overall energy gain obtainable with the method according to the invention (index 1), thanks to the improved use of predicted wind conditions.

The embodiment described above is provided purely by way of an example and it will be understood that other equivalent embodiments are imaginable without departing from the scope of protection of the invention.

1. A method for controlling an aerogenerator for producing electrical energy of a type comprising an arrangement of aerodynamic elements that rotate on a common shaft, sensors for measuring at least a speed of wind incident upon said elements, an alternator unit associated with a rotation of the shaft for generating electrical energy supplied to a use point and/or to a battery or for transmitting a mechanical torque to the shaft, and a control unit associated with the sensor, the method comprising the steps of:
creating, based on measurements of the sensors, a history table of samples representing weather conditions characteristic of an installation site of the aerogenerator for operation of the aerogenerator;
measuring characteristic parameter values of current weather conditions;
selecting, based on the characteristic parameter values of current weather conditions, a sample representative of successive expected weather conditions as a most likely sample in a number; assigning to one or more aerogenerator configuration parameters values associated with the expected weather conditions in order to optimize aerogenerator operation relative to the expected weather conditions.

2. A method according to claim 1, wherein the characteristic parameter values of current weather conditions comprise one or more of wind gust duration, wind speed, wind direction, temperature, relative humidity and air density.

3. A method according to claim 1, wherein the step of assigning to one or more aerogenerator configuration parameters values associated with the expected weather conditions comprises a step of correlating one or more configuration parameters of the aerogenerator and one or more obtainable performance specifications.

4. A method according to claim 3, wherein the correlating step comprises a correlation between an aerogenerator power curve as a function of a ratio between a peripheral speed of the elements and the speed of the wind incident upon the elements.

5. A method according to claim 3, wherein the obtainable performance specifications comprise at least one of aerogenerator efficiency, alternator maximum power output and alternator actual power output.

6. A method according to claim 1, wherein the history table is updated continuously by successive storage at regular intervals of said characteristic parameter values of said current weather conditions measured over time.

7. A method according to claim 1, wherein values in the table are updated and/or the sample created through a machine learning process.

8. A method according to claim 1, wherein the step of assigning values to one or more aerogenerator configuration parameters comprises controlling an electrical load applied to the alternator unit and/or the mechanical torque transmitted by the shaft.

9. A method according to claim 1, further comprising a step of:
measuring a wind speed, lower than a preset lower threshold speed value associated with the aerogenerator, and inducing through the alternator unit a rotation speed of the shaft greater than a lower rotation threshold associated with the aerogenerator.

10. A method according to claim 9, wherein the preset lower threshold speed value is between 2 m/s and 4 m/s.

11. A method according to claim 8, wherein controlling the alternator unit comprises actively and permanently following a maximum power output of the alternator unit.
